(19) United States
(12) Patent Application Publication
(10) Pub. No.: US 2012/0296965 A1
(43) Pub. Date: Nov. 22, 2012

(54) DETECTING POTENTIALLY ABUSIVE ACTION IN AN ONLINE SOCIAL NETWORK

(75) Inventor: Kumar S. Srivastava, Sammamish, WA (US)

(73) Assignee: Microsoft Corporation, Redmond, WA (US)

(21) Appl. No.: 13/110,174

(22) Filed: May 18, 2011

(51) Int. Cl. G06F 15/16

(52) U.S. Cl. 709/204

(57) ABSTRACT

One or more techniques and/or systems are disclosed for detecting a potentially abusive action for an online social network of a user. A network expansion profile and/or communications profile may be determined for the online social network of the user, by tracking user actions while building and/or maintaining the online social network. A reputation profile, such as a rating, for the online social network can be determined by combining information from the network expansion profile for the online social network and/or the communication profile for the online social network. Based upon the determined reputation profile, an action of the online social network, such as sending a communication, may be identified as potentially abusive and thus be treated as such (e.g., be accompanied by a warning to intended recipients that the communication may be from a spammer).

### BACKGROUND

In a computing environment, a user can go online (e.g., using a browser to access the Internet) to connect and socialize with other online users. Such online interactions may be referred to as social networking or occurring within a social network (e.g., within an infrastructure provided by a social network service). A user's online social network (e.g., afforded through a social network service) may comprise a plurality of communication and connection modes, such as email, instant message (IM), VoIP, texting, voice calls and/or blogging, etc. that allows a user to connect and interact with a variety of contacts or other online users.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

An ever increasing shift toward online social networking for communication can make social networks an attractive target for abuse. For example, because of the increasing amount of traffic and reach of social networks, abuse through an online social network may have a very high ROI for a malicious user (e.g., using spam, spim, malware, phishing, scamming and/or adware attacks, etc.). For example, because users are more likely to have a higher trust level with those to which they are connected via a social network, the abuser may use that trust to get a higher ROI than they otherwise could achieve if they merely sent large amounts of (blind) spam emails, for example.

Accordingly, one or more techniques and/or systems are disclosed that can mitigate abuse of/from a user's social network, may protect a user and/or others from malicious intrusions into their social network and/or can offer a better experience for legitimate users of the online social network. A user's social network expansion efforts can be tracked, for example, while they are building their online social network, such as by inviting others to join their network (e.g., using email, text, IMs, etc.). Further, the user's social network based communications can be tracked, for example, such as how they interact with contacts of the online social network. Additionally, a perception or reputation of the user's online social network can created and updated based on the how the user attempts to expand their network and/or how they communicate within the network, for example. This reputation may be used to determine whether the online social network of the user is potentially being used for abusive purposes, for example.

In one embodiment of detecting a potentially abusive action for an online social network of a user, a reputation profile for the online social network can be determined. Determining the reputation profile can be based on a network expansion profile for the online social network and/or a communication profile for the online social network. Further, a potentially abusive action of the online social network can be detected using the reputation profile.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for detecting a potentially abusive action for an online social network of a user.

FIG. 2 is a flow diagram illustrating an example embodiment where one or more portions of one or more techniques described herein may be implemented.

FIG. 3 is a flow diagram illustrating an example embodiment where one or more portions of one or more techniques described herein may be implemented.

FIG. 4 is a flow diagram illustrating an example embodiment where one or more portions of one or more techniques described herein may be implemented.

FIG. 5 is a component diagram illustrating an exemplary system for detecting a potentially abusive action for an online social network of a user.

FIG. 6 is a component diagram illustrating an example embodiment where one or more systems described herein may be implemented.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A method may be devised that provides for tracking usage of a user's online social network. For example, the user's online social network can comprise, among other things, a network of contacts, connections between the contacts and the user and/or communications between the contacts and user, etc. The user can, among other things, attempt to expand their social network and communicate with contacts in the social network, and these (and/or other) interactions may be tracked to provide an overall profile of the user's online social network. This information may be used to identify whether the online social network is being used for potentially abusive purposes, such as to send spam, for phishing, and/or spreading malware/adware, for example (e.g., such as where the social network of a legitimate user has been hijacked and is being used for abusive purposes and/or where the social network is that of a malicious user/entity from the outset).

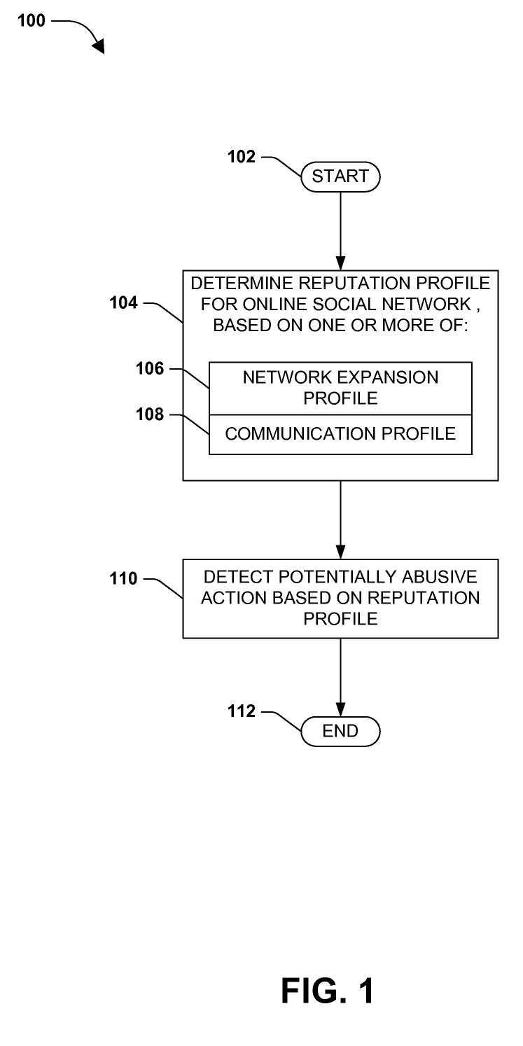

FIG. 1 is a flow diagram illustrating an exemplary method for detecting a potentially abusive action for (e.g., originating from, occurring within, etc.) an online social network of a user. The exemplary method 100 begins at 102, and involves determining a reputation profile for the online social network, at 104. Determining the reputation profile can be based on a network expansion profile for the online social network, at 106, and/or a communication profile for the online social network, at 108.

In one embodiment, a social network can comprise, among other things, a communication account, an online community, an online identity using a plurality of communication modes, a communication network, an online identity linked to a plurality of online sites/networks, etc., or a combination of these, for example, where the user is linked to a plurality of contacts (e.g., other users/entities), via a variety of connections (e.g., common sites, networks, communities, etc.), using one or more modes of communication (e.g., email, IM, posting, blogging, micro-blogging, video chat, etc.). As an example, when the user starts (e.g., begins to establish or build) or joins an online social network, the network of contacts, connections and/or modes of communication, for example, can be continually built and expanded. In one embodiment, a way in which the user expands their online social network can help define their network expansion profile (e.g., at 106).

For example, the user can expand their online social network by inviting and/or contacting friends, relatives, professional contacts, social contacts, etc. using one or more modes of communication associated with the user's online social network. As an illustrative example, the user can send an email to a contact, asking the contact to add the users email address associated with the users online social network to the contact's address book. As another illustrative example, some online communities provide for sending formalized “invitations” to connect or join an online community. In this example, the user can send the invitation to one or more contacts, asking the contact(s) to join the community or link with the user in the community, which is associated with the users online social network.

Further, the user's online social network can comprise one or more modes of communication, such as email, instant message (IM), texting, online chat, video message/chat, posting to a social stream, blogging, micro-blogging, and others, for example. In one embodiment, a way in which the user sends and receives communications, as well as how the user's communications are responded to, may be used to help define their communication profile (e.g., at 108). As an illustrative example, a typical user may utilize a variety of communication modes to communicate with contacts. Additionally, as an example, typical users of an online social network will receive communications, and not merely be an initiator of communications (e.g., where spammers, on the other hand, generally merely send (but receive few to no) communications). Also, receivers of the user's communications can respond in a variety of ways, such as by replying, ignoring, deleting, blocking, and/or reporting (e.g., as abusive).

In one embodiment, the reputation profile for the online social network of the user may define or characterize how the user utilizes the online social network. For example, the reputation profile may indicate that the user is sending out far more invitations than typical users, that the invitations are being sent to other users to which the user may have not previously communicated, that the user sends a lot of outgoing messages but receives few responses and/or that the user typically communicates by modes that make it easier to remain anonymous. In this example, one may infer that the user is potentially using the online social network for abusive purposes.

At 110 in the exemplary method 100, a potentially abusive action of the online social network is detected, based at least in part upon the reputation profile. An action of the user's online social network can comprise a communication (e.g., email, IM, text, posting, blog, etc.), an invitation to join the user's social network, and/or some action that attempts to link the users social network to another user, for example. In one embodiment, the reputation profile of the online social network may meet a threshold that indicates the social network is being used for potentially abusive activity.

For example, malicious users may set up the online social network for abusive purposes. As an example, the malicious user may attempt to spread spam (e.g., unwanted advertisements or promotions) to other users connected with the social network, for profit or notoriety. The malicious user may attempt to spread malware to connected users, which may be used to extract secret information from the connected user (e.g., passwords, financial info, etc.), for example. The malicious users may set up the abusive online social network in a way that attempts to hide its true purpose, using a cover ID, such as a known entity, for example. In this way, other users may be tricked into connecting with the malicious user's online social network. In one embodiment, if the online social network is determined to be potentially abusive, for example, as indicated by the reputation profile, an action attempted by the online social network may be identified as potentially abusive.

Having detected the potentially abusive action, the exemplary method 100 ends at 112.

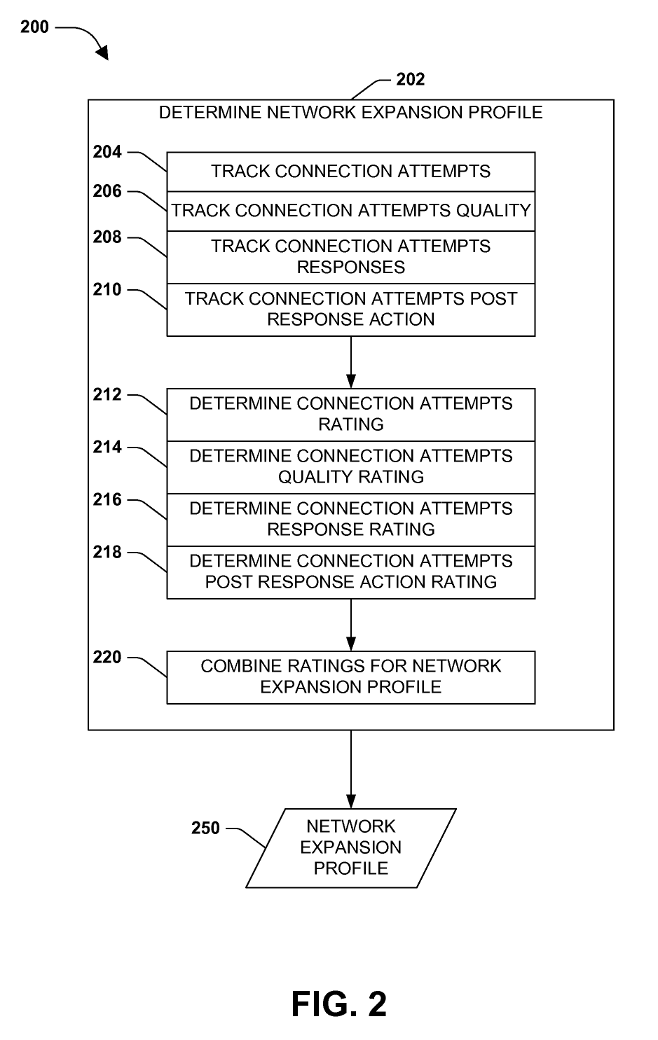

FIG. 2 is a flow diagram illustrating an example embodiment 200 where a network expansion profile may be identified for an online social network. Beginning at 202 in the example embodiment 200, determining the network expansion profile can comprise tracking attempts by the online social network to connect with other users. For example, a user of the online social network can attempt to expand the network of connections by connecting with new users who may respond in a variety of ways and/or may perform some sort of post response action (e.g., and who may, in turn, provide additional opportunities for new connections).

At 204, tracking attempts by the online social network to connect with other users (e.g., to determine expansion efforts/profile) can comprise tracking connection attempts sent from the online social network, for another user to join the online social network. For example, a connection attempt can comprise a type of “formal invitation” for the other user to join one or more portions of the online social network. As an illustrative example, a web aggregation site may comprise a portion of the online social network of the user, where, utilizing a site account, the user may aggregate content, such as news feeds, contacts' information, emails, micro-blog stream feeds, instant messaging, etc. In this example, the user may send an invitation from the web aggregation site to another user, which invites the other user to connect to the user's online social network using the aggregation site (e.g., to provide content to the site and/or peruse the aggregated content on/of the site).

As another example, a connection attempt can comprise a communication sent to another user, who is not connected to the online social network. As an illustrative example, the user of the online social network may create an email sent out to one or more other users, asking for contact information and/or to verify the connection address used for sending the communication (e.g., an email address to which the email was sent). In this way, in this example, the online social network may be expanded by adding contacts' connection information (e.g., email address(es)) to the network, such as to an address book for the social network.

In one embodiment, a variety of aspects/characteristics of a connection attempt can be tracked to develop the network expansion profile. For example, a number of connection attempts sent by the user can be tracked, as well as a number of invites sent per day and/or an average number of invites sent per day, among other statistics. Further, as an example, a destination of the invitation (e.g., who the invitation is being sent to) can be tracked, along with a degree of separation between the user/sender and destination/recipient, for example. Additionally, as an example, a content of the connection attempt, such as pictures, URLs, Phone numbers, IP address, CC information, physical address and/or connections in common, etc. can be tracked.

Other specific characteristics of the connection attempts may also be tracked, such as an IP address of a client used to send the connection attempt (e.g., and a most likely IP range the recipient has used in the past to access such social network communication); a time zone and/or geographical location used to send the connection attempt (e.g., to deduce a physical distance between the sender and recipient); an originating platform, service or device used to send the invitation; as well respective connection attempts that are sent from the same platform/service/device/IP address from different senders. In one embodiment, one or more of these connection attempt characteristics can be tracked and used to help determine the network expansion profile.

At 206 in the example embodiment 200, tracking attempts by the online social network to connect with other users (e.g., to determine expansion efforts/profile) can comprise tracking a connection attempt quality. In one embodiment, the quality of the connection attempt may be determined by identifying whether or not the connection attempt comprises sufficient information to allow a recipient to respond appropriately. For example, where the connection attempt comprises and invitation, the sufficiency of information may be determined by asking recipients to provide notice that the invitation comprised sufficient information to respond (e.g., either accept or reject). In this example, notification functionality may be implemented using a UI element (e.g., a radio box or button in the invitation) that provides notification (e.g., to the site creating the invitation) about a sufficiency of, or lack of, information needed to make the response decision.

At 208, tracking attempts by the online social network to connect with other users (e.g., to determine expansion efforts/profile) can comprise tracking a response to the connection attempt by a receiver of the connection attempt. For example, users in social networks can email, IM, chat, phone, VoIP, ping, post personal status messages privately or publicly. In this example, a response to any of these forms of connection attempts from other users can be tracked, where responses may be categorized into positive, negative and neutral categories. For example, a response to the connection attempt can comprise an acceptance, an indication to ignore the connection attempt, an indication to block the sender from attempting to connect further and/or a report (e.g., to an administrator of a site) of the connection attempt as an abusive action. In this example, an acceptance may be positive, ignore may be neutral, while block and report may be negative.

In one embodiment, these responses can be tracked to help determine the network expansion profile. Further, for example, other information related to the response may be tracked, such as a device used to respond, a platform used to respond, the IP address of respondee, a time between opening the connection attempt and a response, a geographic location/time zone of response, a service used to respond, and/or a user's (e.g., the responder's) interaction with the content in the invitation.

At 210 in the example embodiment 200, tracking attempts by the online social network to connect with other users (e.g., to determine expansion efforts/profile) can comprise tracking a post response action by the receiver of the connection attempt. For example, post response behavior after acceptance of a connection attempt can comprise annotation of the sender as a preferred contact, or as a non preferred contact. As another example, after rejecting the connection attempt, the post response behavior may comprise blocking the sender from further contact with the recipient and/or reporting the sender to an administrator for the service providing the invitation or communication. In one embodiment, one or more of these tracked post-response behaviors can be used to help determine the network expansion profile.

In one embodiment, determining the network expansion profile can comprise rating respective tracked aspects of the connection attempts. It will be appreciated that a rating may comprise a characteristic of the connection attempt, and is not limited to a numerical rating, for example. Nevertheless, in one embodiment, the rating may comprise a numerical rating based on some statistical value. For example, an aspect of the connection attempts may be rated against that of typical online social networks. As an illustrative example, a number of connection attempts sent from a particular portion of the online social network can be compared to typical connection attempts sent from that portion of a typical online social network (e.g., number of connection attempts sent via instant message can be compared to number of connection attempts sent via instant message in typical online social networks).

At 212, a connection attempts rating may be determined. In one embodiment, tracked aspects of the connection attempts (as described above) may be used to develop a rating for the connection attempts. As an example, a connection attempts rating can comprise or consider social networks from which connection attempts are sent, social networks to which connection attempts are sent, modes of delivery of connection attempts, modes of originating connection attempts, geographic locations from which connection attempts are sent, locations of recipients of connection attempts, IP addresses and/or ranges from which connection attempts are sent, time zones and/or times that connection attempts are sent, time zones and/or times that connection attempts are received, markets from which connection attempts originated, markets of recipients of connection attempts, language of connections attempts and/or others. Further, a number of connection attempts sent, such as per day, week, etc., as well as a number of connection attempts sent vs. number of connection attempts received can be used for the rating.

At 214 in the example embodiment 200, a connection attempts quality rating may be determined. For example, a connection attempt quality rating may be based on a percentage (e.g., or some other statistical value) of invitations containing sufficient information to allow the recipient to make the appropriate invitation response decision (e.g., a majority of the connection attempts were of a high quality). As described above, the connection attempt quality rating may also be based on a comparison of quality to typical connection attempt quality.

At 216, a connection attempts response rating can be determined. For example, a connection attempts response rate can comprise one or more statistics for one or more aspects of the responses to the connection attempts by the online social network (e.g., relatively few connection attempts were responded to possibly indicative of abusive spamming). As an example, a likelihood of invitation acceptance (e.g., ratio or percentage of sent per accepted) may be combined with a likelihood of invitation declined, a likelihood of invitation ignored, a likelihood of invitation blocked and/or a likelihood of invitation reported to arrive at a connection attempts response rating.

As an illustrative example, if a typical online social network comprises an acceptance rate of ninety percent, and the online social network for the user comprises an acceptance rate of forty five percent, the comparison rating for responses may comprise fifty percent of typical (e.g., forty five percent divided by ninety percent). In this illustrative example, a lower rating against typical may comprise an indication of a poor rating, which can comprise one indication (e.g., of several) of a potentially abusive account.

At 218, a connection attempts post response actions rating may be determined. In one embodiment, the rating can account for negative, neutral and positive post-response actions. For example, when the recipient blocks the sender from further contact via the connection used to communicate, and/or reports the sender to an administrator for the service, a negative rating may be applied (e.g., lower a ratings score). As another example, when the recipient annotates the sender as a preferred contact, and/or saves the communication, a positive rating may be applied (e.g., raising the ratings score). Further, in this example, if the recipient provides no post-response action (e.g., or performs a neutral action) no change may be made to the rating.

At 220 in the example embodiment 200, the ratings for the network expansion profile can be combined. In one embodiment, one or more of the ratings for the network expansion profile, such as the connection attempts rating, connection attempts quality rating, connection attempts response rating and/or connection attempts post response actions rating can be combined to determine the network expansion profile 250. In one embodiment, the network expansion profile 250 can comprise a rating that is a combination of the one or more network expansion ratings described above.

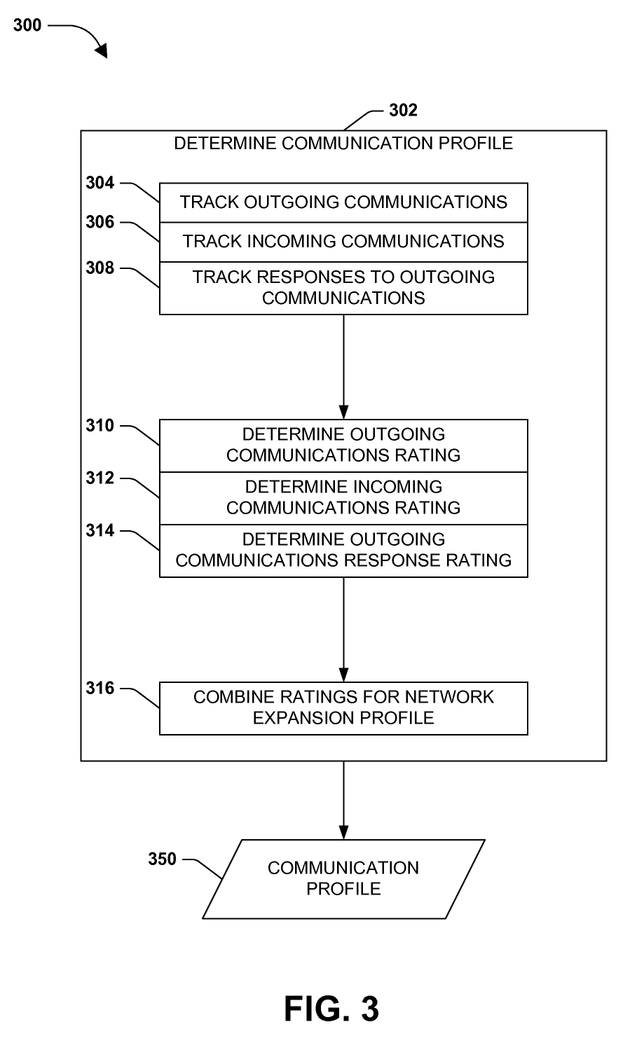

FIG. 3 is a flow diagram illustrating an example embodiment 300 where a communication profile may be identified for the online social network. Beginning at 302 in the example embodiment 300, determining the communication profile can comprise tracking one or more modes of communications for the online social network. For example, a user of the online social network may communicate with one or more contacts connected to the social network using a variety of communication modes, such as by email, IM, chat, text, phone, VoIP, ping, posting personal status messages privately or publicly, blogging, and/or micro-blogging. Further, as an example, the user may receive (responsive) communications in a variety of ways.

At 304, determining the communication profile can comprise tracking outgoing communications from the online social network. For example, the outgoing communications can be tracked in a similar manner as described above for the connection attempts. That is, for example, the number, destination and content of the communications can be tracked. Further, in this example, information about the sending location, address, platform, etc. can be tracked, along with corresponding information of/for one or more (intended) recipients. Additionally, in this example, content and mode of communication can be tracked.

At 306, incoming communications to the online social network can be tracked in order to determine the communication profile. Much like the outgoing communications, the information related to the incoming communications can be tracked. For example, the user can receive incoming communications over a variety of modes utilized by the online social network from one or more contacts connected to the online social network. As an illustrative example, the online social network for the user may comprise connections to contacts over an online service (e.g., a friend connection site, or aggregation site), an email service, a text and phone service and/or others. In this example, the user may receive incoming communications (e.g., emails, posting, texts, IMs, calls, etc.) utilizing one or more of these connections.

In one embodiment, one or more aspects described above for the connection attempts and/or outgoing communications may be tracked for the incoming communications, singly or in combination. For example, the number, origin, mode of communication and/or content, etc. of the incoming communications can be tracked.

At 308 in the example embodiment 300, determining the communication profile can comprise tracking responses to the outgoing communications. That is, when a contact of the online social network receives a communication from the online social network of the user, information indicating how the recipient responds can be tracked. For example, a recipient can respond in a variety of ways, such as replying, ignoring, deleting, saving, blocking the sender and/or reporting the communication as abusive (e.g., to an administrator of the service providing the recipient with the communication). Further, a time between opening/receiving the communication and a response can be tracked. Additionally, content of the reply communication may be tracked, as well as other information related to the response, for example.

In one embodiment, determining the communication profile for the online social network can comprise rating respective tracked aspects of the communications. It will be appreciated that a rating for the communications may comprise a characteristic of the communications, and is not limited to a numerical rating, for example. Nevertheless, in one embodiment, the communication-based ratings may comprise a numerical rating, for example, based on some statistical value. For example, an aspect of the communications may be rated against typical user online social network. As an illustrative example, a number of communications sent from a particular portion of the online social network (e.g., emails) can be compared to typical communications sent from that portion of a typical online social network.

At 310 in the example embodiment 300, determining the communication profile can comprise determining an outgoing communications rating for outgoing communications from the online social network. In one embodiment, in a similar manner as described above for the connection attempts rating (e.g., at 212 of FIG. 2), the tracked aspects of the outgoing communications may be used to determine a rating. As an example, an outgoing communications rating can comprise or consider recipient social networks, mode of outgoing communication delivery, mode of outgoing communication origination, geographic location of sender and/or recipient, IP address and range of outgoing communication, time outgoing communication sent, language of outgoing communication and/or others.

Further, as an example, a number of outgoing communications sent, such as per day, week, etc., as well as a number of outgoing communications sent per (return) incoming communications received by the user of the social network may be used to determine the rating. A rating for one or more of the respective tracked aspects of the outgoing communications may be determined, for example, such as by comparing the information to typical outgoing communications for one or more typical online social networks. As an illustrative example, the preferred mode of communication and number of messages for the preferred mode may be compared to that of a typical online social network. Moreover, often abusive users of online social networks prefer to use those modes of communication that may be difficult to verify true identity and/or those which contacts may tend to have a high level of trust (e.g., instant messaging), and thus such modes of communication of the online social network may be compared to those of typical online social networks to possibly more readily determine abusive actions.

At 312 in the example embodiment 300, determining the communication profile can comprise determining an incoming communications rating for incoming communications to the online social network. In one embodiment, the tracked aspects of the incoming communications, as described above, can be used to determine the incoming communications rating. For example, the origin, content, originating location, platform and/or mode of communication, etc. of the incoming communications may compared against typical statistical information for a typical online social network to generate a rating.

In one embodiment, the rating for the incoming communications may be determined in a similar manner as the outgoing communications rating, described above. As an example, a ratio of incoming communications to outgoing communications can be identified. Further, the ratio (e.g., or some other statistical comparison) may be compared with a ratio for a typical online social network, for example, to generate a rating for the incoming communications.

At 314, determining the communication profile can comprise determining a responses rating for responses to the outgoing communications. The various tracked aspects of the responses to outgoing communications can be used to generate the response rating, for example. In one embodiment, the response rating can comprise a positive, negative or neutral indication of how contacts connected by the online social network respond to the outgoing communications. For example, if contacts report the outgoing communications, a negative rating may be applied. As another example, if the contacts often ignore or delete the outgoing communications, a neutral rating may be applied. Further, as an example, if the connections save or respond to the outgoing communications, a positive rating may be applied. Additionally, the statistics for the responses may be compared against typical online social network statistics to determine a rating, for example.

At 316, the ratings for the communication profile can be combined. In one embodiment, one or more of the ratings for the communication profile, such as the outgoing communications rating, incoming communications rating and/or outgoing communications post response actions rating can be combined to determine the communication profile 350. In one embodiment, the communication profile 350 can comprise a rating, for example, which is comprised of a combination of one or more or the communication ratings described above.

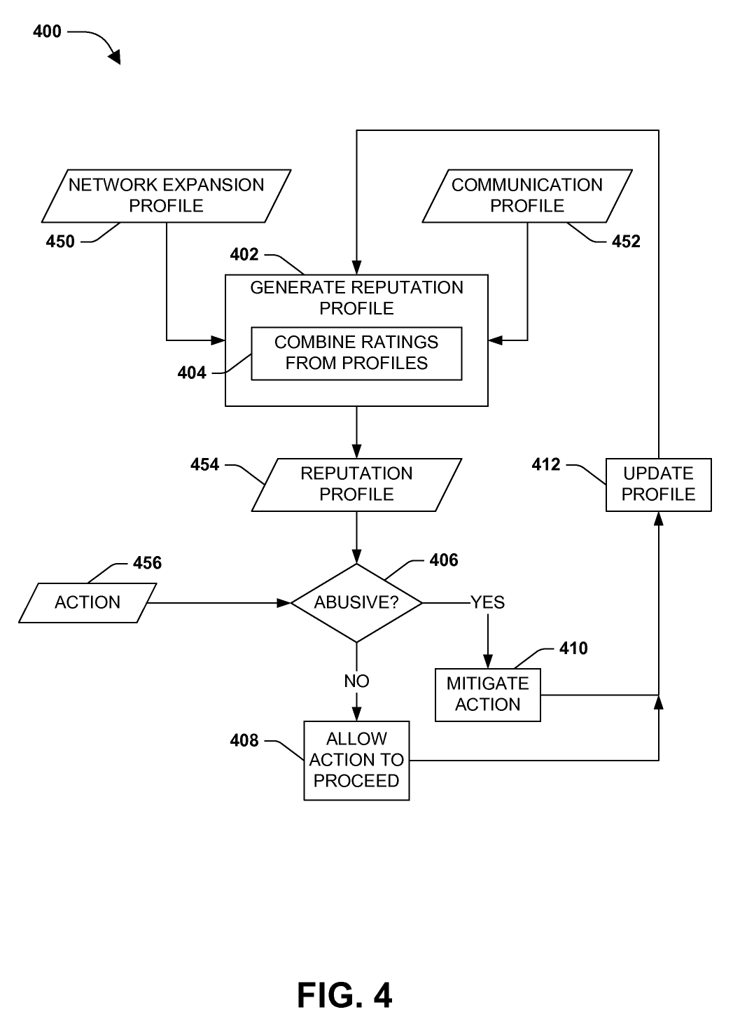

FIG. 4 is a flow diagram illustrating an example embodiment 400 where a reputation profile may be used to identify an abusive action for an online social network. At 402, the reputation profile 454 can be generated for the online social network using a network expansion profile 450 and/or a communication profile 452. For example, a reputation profile may provide an indication of how the online social network is being used, from which, a purpose of the use may be deduced. As an illustrative example, if connections or others respond favorably to invitations and communications from the online social network of a user there is a high likelihood that the user is a human that is using the online social network for typical human online interactions. However, if the connections and/or other users tend to respond negatively to invitations and/or communications and/or the online social network tends to be the initiator of most communications, there is a high likelihood that the user of the online social network is a bot or a malicious user utilizing the online social network for abusive purposes.

In one embodiment, the reputation profile 454 can be generated by combining one or more ratings from the network expansion profile 450 and/or by combining one or more ratings from the communications profile 452, at 404. That is, for example, the reputation profile 454 can comprise a reputation profile rating that comprises a combination of one or more of the network expansion profile ratings (e.g., connection attempts rating, connection attempts quality rating, connection attempts response rating and/or connection attempts post-response action rating) and/or one or more of the communications profile ratings (e.g., outgoing communications rating, incoming communications rating and/or outgoing communications response rating).

As an example, the reputation profile 454 can comprise a reputation quotient that may be assimilated with other online reputation systems, and can be used to influence the user's experience or the reception of their invitations or communication with their recipients. As another example, the reputation rating (e.g., quotient) can be incremented or decremented based on a negative or positive rating from the network expansion profile ratings and/or the communication profile ratings. The reputation profile may be incremented (e.g., improved) if the connection attempts are accepted by a quality user (e.g., verified non-abusive user), if they meet a quality standard (e.g., conform to the user profile, are rated as high quality, match the social network profile of quality, etc.), the communication is rated as high quality by recipients, the communication is responded to by quality recipients, the communication meet the typical online social network profile and/or more. Further, in this example, the reputation profile may be decremented if these qualifications are not met.

In one aspect, when creating the reputation profile for the online social network of the user, indications of potential abusive users can be accounted for by the reputation profile (e.g., rating). For example, other users that are contacts connected to the online social network should typically respond favorably to communications from the online social network, and a lack of such responses may indicate an abusive user/action. Further, as an example, the online social network should not be the initiator of communications most of the time, and thus a lower ratio of communications initiated vs. communications received may indicate a better reputation of the online social network (e.g., likely being used by a human as opposed to a bot). Additionally, for example, if other users are choosing to communicate with online social network of the user, and are expecting a response, it is more likely that the online social network of the user is non-abusive, and the user is a human. In this aspect, for example, this information, and/or more, can be collected and used to build the reputation profile 454.

At 406 in the example embodiment 400, it can be determined whether an action 456 of the online social network is potentially abusive. In one embodiment, determining that the action 456 is potentially abusive can comprise comparing the reputation rating of the reputation profile 454 to a desired abusive action threshold. For example, the desired abusive action threshold may comprise a threshold that is generated from empirical evidence, based on a typical reputation rating for a typical online social network. In this way, if the reputation profile 454 of the online social network deviates sufficiently from the typical reputation rating, the action 456 may be determined to be potentially abusive.

If the action 456 is determined not to be abusive (NO at 406), the action 456 may be allowed to proceed, at 408. If the action 456 is determined to be abusive (YES at 406), processing of the action 456 may be mitigated, at 410. For example, mitigating the action may comprise preventing the action from processing (e.g., not sending the communication). As another example, mitigating the action may comprise delaying the action, such as providing a high latency processing of an invitation or communication. As another example, a user interface (UI) element may indicate a level of untrustworthiness of the action to connections of the online social network (e.g., providing a warning to other users).

At 412, the reputation profile 454 can be updated based the action classification as abusive or not. In one embodiment, ongoing connection attempt information (e.g., expansion) and/or communication information for the online social network may be used to update the reputation profile 454, based on an indication of potentially abusive or not. For example, an online social network for the user may initially comprise a good reputation profile, where the actions are typically determined not to be potentially abusive. In this example, if the user's account becomes compromised (e.g., hacked by a malicious user), a malicious user may start using the network for abusive purposes. The updated reputation profile can be an indication that something has changed, for example, which can be an indicator that the online social network has been compromised. In this way, for example, a user of the compromised online social network may be able to take mitigating measures (e.g., changing security information) and/or warnings can be provided to connections/other users.

A system may be devised for identifying a potentially abusive online social network. Actions undertaken by the online social network of a user can be tracked, such as invitations to join (e.g., for expansion) and other communications, and a profile for the online social network can be identified by the system. The profile may be used to identify whether the online social network is being used for potentially abusive purposes, for example, such as sending spam or malware to contacts connected to the network. In this way, potentially abusive actions may be mitigated.

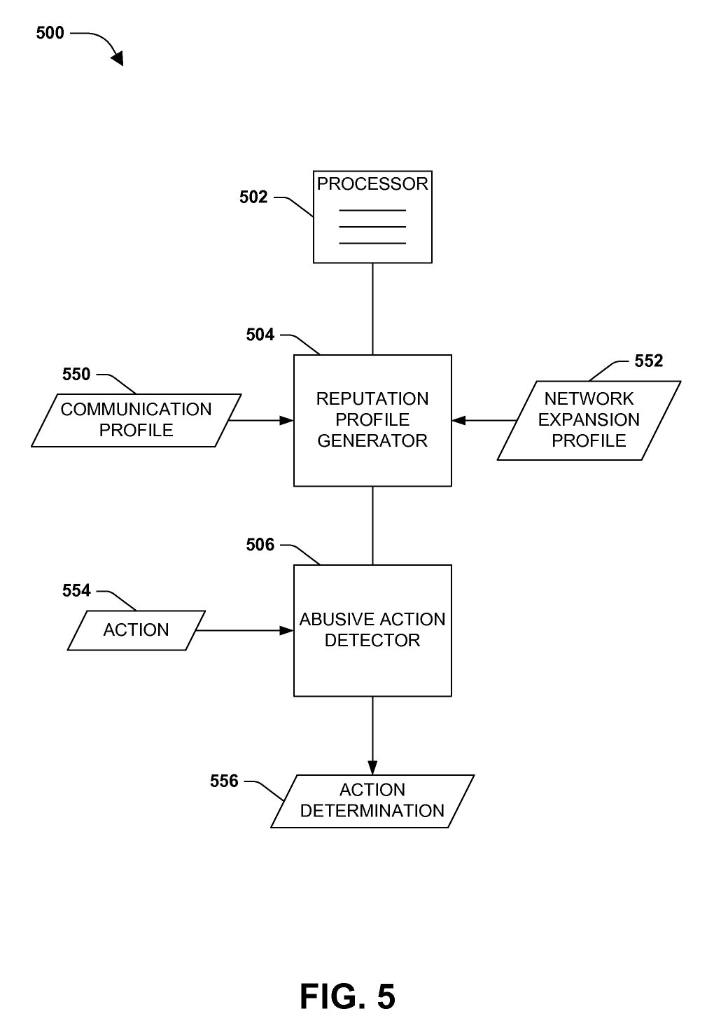

FIG. 5 is a component diagram illustrating an exemplary system 500 for detecting a potentially abusive action for an online social network. A computer-based processor 502 is configured to process data for the system 500, and is operably coupled with a reputation profile generation component 504. The reputation profile generation component 504 is configured to determine a reputation profile for the online social network. The reputation profile generation component 504 may utilize a network expansion profile 552 for the online social network and/or a communication profile 550 for the online social network to determine the reputation profile.

An abusive action detection component 506 is operably coupled with the reputation profile generation component, and is configured to detect a potentially abusive action for the online social network, based at least in part upon the reputation profile. For example, an action 554 that is initiated by the online social network, such as a communication, can be classified by the abusive action detection component 506 using the reputation profile. In this way, in this example, an action determination 556 may comprise an indication that the action 554 of the online social network is potentially abusive, or that that the action is not potentially abusive.

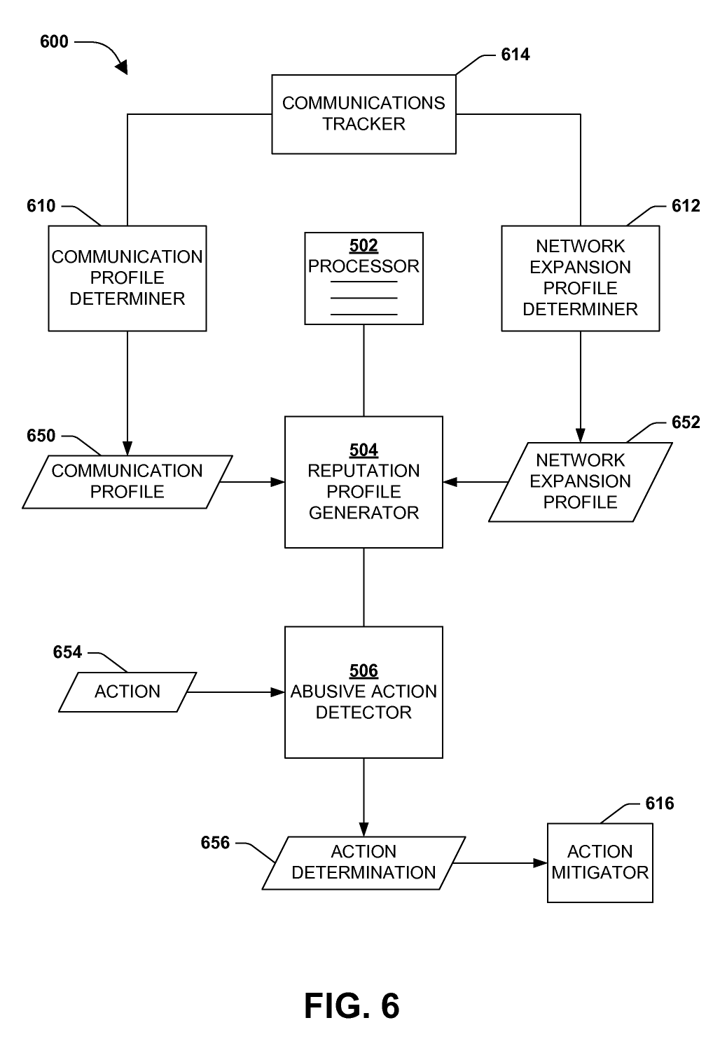

FIG. 6 is a component diagram illustrating one embodiment 600 where one or more systems described herein may be implemented. In this example, an extension of FIG. 5 is provided and thus description of elements, components, etc. described with respect to FIG. 5 may not be repeated for simplicity. A network expansion profile determination component 612 is configured to determine the network expansion profile 652 for the online social network. Further, a communication profile determination component 610 is configured to determine the communication profile 650 for the online social network.

A communications tracking component 614 can be configured to track connection attempt information, which comprises information about attempts of the social network to connect with other users (e.g., for expansion). Further, the communications tracking component 614 can be configured to track communication information for the social network, which comprises information about communications for the social network. For example, the tracked information may be used by the network expansion profile determination component 612 to generate the network expansion profile 612 and/or the communication profile determination component 610 to generate the communication profile 650.

An action mitigation component 616 can be configured to mitigate an action 656 for the online social network, if the action is determined to comprise a potentially abusive action. For example, the abusive action detection component 506 may identify that the reputation profile for the online social network meets a potentially abusive threshold. In this example, the abusive action detection component 506 can generate an action determination 656 indicating that the action 654 of the online social network is potentially abusive. Further, the action mitigation component 616 can mitigate the action 654 based on the action determination 656, for example, by preventing the action from processing, or indicating that the action is potentially abusive in a UI for one or more intended recipient(s).

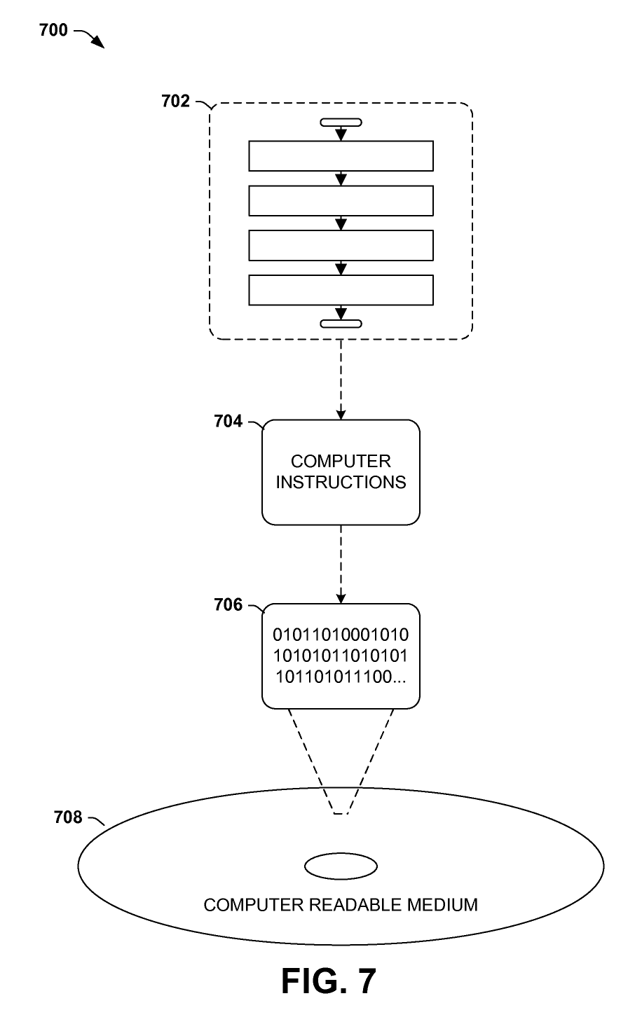

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 708 (e.g., a CD-R, DVD-R, or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary method 100 of FIG. 1, for example. In another such embodiment, the processor-executable instructions 704 may be configured to implement a system, such as at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

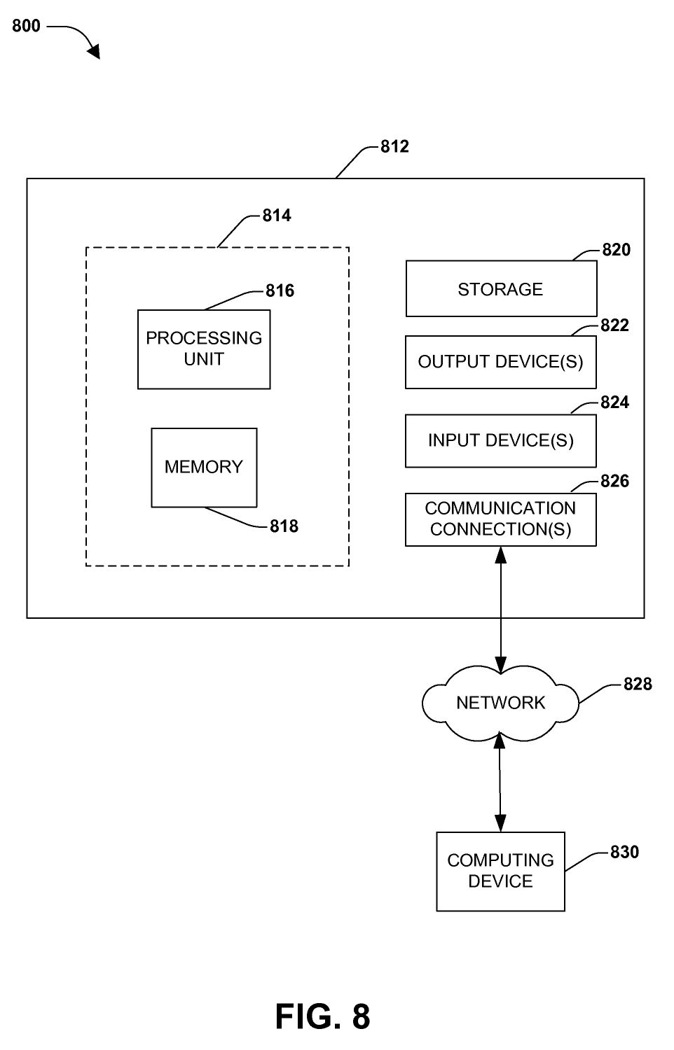

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-based method for detecting a potentially abusive action for an online social network of a user, comprising:
determining a reputation profile for the online social network based at least in part upon one or more of:
a network expansion profile for the online social network; and
a communication profile for the online social network; and
detecting that an action of the online social network is potentially abusive, using a computer-based processor, based at least in part upon the reputation profile.

2. The method of claim 1, comprising determining the network expansion profile for the online social network.

3. The method of claim 2, determining the network expansion profile comprising tracking attempts by the online social network to connect with other users.

4. The method of claim 2, determining the network expansion profile comprising tracking one or more of:
a connection attempt, sent from the online social network, for another user to join the online social network;
a quality of the connection attempt;
a response to the connection attempt by a receiver of the connection attempt; and
a post response action by the receiver of the connection attempt.

5. The method of claim 2, determining the network expansion profile comprising determining one or more of:
a connection attempts rating;
a connection attempts quality rating;
a connection attempts response rating; and
a connection attempts post response actions rating.

6. The method of claim 1, comprising determining the communication profile for the online social network.

7. The method of claim 6, determining the communication profile comprising tracking one or more modes of communications for the online social network.

8. The method of claim 6, determining the communication profile comprising tracking one or more of:
an outgoing communication from the online social network;
an incoming communication to the online social network; and
a response to the outgoing communication.

9. The method of claim 6, determining the communication profile comprising determining one or more of:
an outgoing communications rating for outgoing communications from the online social network;
an incoming communications rating for incoming communications to the online social network; and
a responses rating for responses to the outgoing communications.

10. The method of claim 1, determining a reputation profile comprising generating a reputation rating for the online social network.

11. The method of claim 5, determining a reputation profile comprising combining one or more ratings from the network expansion profile.

12. The method of claim 9, determining a reputation profile comprising combining one or more ratings from the communications profile.

13. The method of claim 10, determining that an action of the online social network is potentially abusive comprising comparing the reputation rating to a desired abusive action threshold.

14. The method of claim 1, comprising:
allowing the action of the online social network to proceed if the action is determined not to be abusive; else mitigating processing of the action.

15. The method of claim 1, comprising updating the reputation profile based on one or more of:
ongoing connection attempt information for the online social network; and
ongoing communication information for the online social network.

16. A system for detecting a potentially abusive action for an online social network, comprising:
a computer-based processor configured to process data for the system;
a reputation profile generation component, operably coupled with the processor, configured to determine a reputation profile for the online social network based at least in part upon one or more of:
a network expansion profile for the online social network; and
a communication profile for the online social network; and
an abusive action detection component, operably coupled with the reputation profile generation component, configured to detect a potentially abusive action for the online social network, based at least in part upon the reputation profile.

17. The system of claim 16, comprising:
a network expansion profile determination component configured to determine the network expansion profile for the online social network; and
a communication profile determination component configured to determine the communication profile for the online social network.

18. The system of claim 16, comprising a communications tracking component configured to perform one or more of:
track connection attempt information, comprising information about attempts of the social network to connect with other users; and
track communication information for the social network, comprising information about communications for the social network.

19. The system of claim 16, comprising an action mitigation component configured to mitigate the action for the online social network if the action is determined to comprise a potentially abusive action.

20. A computer readable medium comprising computer executable instructions that when executed via a processor on a computer perform a method for detecting a potentially abusive action for an online social network, comprising:
determining a network expansion profile for the online social network comprising determining one or more of:
a connection attempts rating;
a connection attempts quality rating;
a connection attempts response rating; and
a connection attempt post response actions rating;
determining a communication profile for the online social network comprising determining one or more of:
an outgoing communications rating for outgoing communications from the online social network;
an incoming communications rating for incoming communications to the online social network; and
a responses rating for responses to the outgoing communications;
determining a reputation profile for the online social network based at least in part upon the network expansion profile for the online social network and the communication profile for the online social network, comprising generating a reputation rating for the online social network; and
detecting that an action of the online social network is potentially abusive, comprising comparing the reputation rating to a desired abusive action threshold.
